(19) United States
(12) Patent Application Publication
(10) Pub. No.: US 2006/0159514 A1
(43) Pub. Date: Jul. 20, 2006

(54) Forged locking assembly

(76) Inventor: Gerhard Schussler, Obernberg (DE)

Correspondence Address: BACON & THOMAS, PLLC, 625 SLATERS LANE, FOURTH FLOOR, ALEXANDRIA, VA, 22314, US

(21) Appl. No.: 11/294,523

(22) Filed: Dec. 6, 2005

(30) Foreign Application Priority Data
Dec. 6, 2004 (DE) DE-202004018828.7

(51) Int. Cl. F16B 2/14

(52) U.S. Cl. 403/409.1

(57) ABSTRACT

A locking assembly for the shrink, or frictional, connecting of a shaft with a hollow shaft or the like. The locking assembly includes: A radially inwardly lying, compression ring, whose outside includes at least one conical surface; and at least one radially outwardly lying, pressure ring, whose inside includes a conical surface, which interacts with the conical surface of the compression ring, so that, upon axial tightening, the compression ring is compressed. This locking assembly is distinctive in that the pressure ring is a forged pressure ring and the surface of the forged pressure ring is at least partially untreated, at least on its outside. The result of this is a locking assembly of increased strength.

### FIELD OF THE INVENTION

The invention relates to a locking assembly for shrink (i.e. interlocking because of forces) , or frictional, connecting of a shaft with a hollow shaft or the like. The locking assembly includes: a radially inwardly lying, compression ring, whose outside includes at least one conical surface; and at least one pressure ring, whose inside includes a conical surface, which interacts with the conical surface of the compression ring, such that, upon axial tightening, the compression ring is compressed.

### BACKGROUND OF THE INVENTION

Locking assemblies of this type possess at least one pair of conical, interacting surfaces and have been known for a long time. Reference is made, in this connection, to DE-PS 2,441,400, DE 3,323,683 C2 and DE 2,601,138 A1. Also already known are locking assemblies utilizing two pairs of conical, interacting surfaces. These are coupling elements wherein the two pairs of surfaces are axially displaced from one another. Such a machine element is also referred to as a shrink disc, or shrink disk. Representative of such shrink discs are the examples shown in DE 198 28 628 C5 and the other publications mentioned there.

The action of such locking assemblies relies always on the fact that the axial tightening forces on the one or more pairs of conical surfaces are transformed, on the basis of the principle of the wedge, into radial forces. At least one of the rings forming the locking assembly can, in such case, exhibit a gap extending in the axial direction. Expediently, the compression ring has such a gap.

Shrink discs of this type and, especially, the pressure rings for such locking assemblies, including shrink discs, have, until now, been manufactured from steel rod material, by, for example, cutting from such a rod a disc of appropriate thickness. Subsequently, this disc was turned, for instance in a lathe, and heat treated. Pressure rings produced in this way frequently crack, however, especially in the case of product misuse.

### SUMMARY OF THE INVENTION

An object of the present invention is to provide a locking assembly, or shrink disc, having an increased strength.

This object is achieved by a locking assembly for shrink, or frictional, connecting of a shaft with a hollow shaft or the like, which comprises: a radially inwardly lying compression ring whose outside surface includes at least one conical surface portion, and at least one radially outwardly lying pressure ring whose inside surface includes a conical surface portion which interacts with the conical surface portion of the compression ring, so that upon axial tightening, the compression ring is compressed. Wherein the pressure ring is a forged pressure ring and the surface of the forged pressure ring, at least on its outside, is at least partially untreated.

Because it is easier to illustrate, the invention will be explained in more detail below on the basis of a shrink disc, wherein the outer surface of the compression ring is in the form of a double cone, and two pressure rings having oppositely tilted, conical surfaces are present, each of which interacts with its own one of the two conical surfaces of the compression ring. These explanations are, however, equally valid for a locking assembly using only one such pressure ring.

An important feature of the invention is to be seen in the fact that the pressure ring which is used is a forged pressure ring. This means that the pressure rings are, at least in part, manufactured as forged parts. Expediently, the entire pressure ring is manufactured as a forged part.

Thus, the pressure ring used in the invention can, for example, be forged in a die, for example with a hammer. Subsequently, the intermediate obtained in this way is de-flashed and annealed. It is then subjected to an internal boring process and to further turning, for instance in a lathe, in order to produce a finished pressure ring.

A further significant feature of the forged pressure ring, as used, is that its surface, at least its outside surface, is partially, or regionally, untreated. In other words, the forged skin remains, at least in the region of the outer surface, partially untreated.

At other locations, the forged pressure ring is, in contrast, treated, for example turned. This is true, for example, for the conically-developed, inside surface, for this must be smooth, in order that it can interact with the corresponding conical surface of the compression ring. Usually, also the face of the pressure ring is turned.

In the untreated forging skin, the flow lines in the material are not damaged. The pressure rings, in this way, gain an increased safety in loading. Additionally, by not machining the forged surfaces, resetting of the machine tools and machining costs are saved. By using forged parts, the material properties are equal in the direction of loading. In the case of parts, however, which were manufactured from rods according to the state of the art, the flow lines, or material fibers, run crosswise to the loading direction.

In a preferred form of embodiment, the outside of the pressure ring has an axially outwardly lying, edge region and an axially inwardly lying, ring region. In other words, the outside of the pressure ring is divided into an outer ring region and an inner ring region. In such case, the surface of the outside of the pressure ring can be untreated in the outer ring region or in the inner ring region and, consequently, present the forged skin. Preferably, the axially inwardly lying, ring region of the outside is untreated.

In an additionally preferred form of embodiment, the pressure ring has a smaller outer-diameter in the axially inwardly lying, ring region than in the axially outwardly lying, ring region. In this case, the pressure ring is preferably untreated in the axially inwardly lying, ring region. For the manufacture of a pressure ring of this type, a die with a shoulder can be used. The intermediates obtained in this way then have an outside, or outer edge, with two regions, with the one region having a smaller outer diameter than the other region. Then, the only step that still has to be taken is to turn the axially outwardly lying, ring region. This means, for example, that the axially outer ring region is cleaned and then turned, so that the axially outwardly lying, ring region has a smooth, chrome-like appearance.

The outer diameter of the axially outwardly lying, ring region remains preferably constant in the axial direction. The outer diameter of the axially inwardly lying, ring region can decrease from that of the treated ring region as one proceeds axially inwards, so that, in side view, an incline is present.

Also the surface of the axially inwardly lying face of the pressure ring is preferably untreated and presents the forged surface.

In the pressure ring, depressions or recesses are provided, which extend from radially outwards to radially inwards and which are arranged with an even distribution in the peripheral direction. These depressions are arranged in the area of the axially inwardly lying, ring region.

Finally, a further option of the invention is to leave almost the entire pressure ring unmachined, so that the unmachined, forged surface is present in almost all regions. The only parts machined, then, are the bores and the bearing surfaces of the tightening screws (or bolts), to the extent that such tightening screws are used.

The invention will now be described in greater detail on the basis of preferred forms of embodiment illustrated in the accompanying drawings, the figures of which show as follows

### BRIEF DESCRIPTION OF THE DRAWINGS

FIGS. 1a, 1b and 1c are a perspective view, a front view in the axial direction and a side view, partially sectional view, respectively of a locking assembly of the invention, in the form of a shrink disc having two pressure rings, a compression ring and six tightening screws;

FIGS. 2a, 2b and 2c are a perspective view a front view in the axial direction and a side view, respectively of the shrink disc, according to FIGS. 1a, 1b and 1c;

FIGS. 3a, 3b and 3c are a perspective view, a front view and a side view, partially sectional along line A-A of FIG. 3b, respectively of a locking assembly of a second embodiment of the invention;

FIGS. 4a, 4b and 4c are a perspective view, a front view in the axial direction and a side view, respectively of the shrink disc according to FIGS. 3a, 3b and 3c;

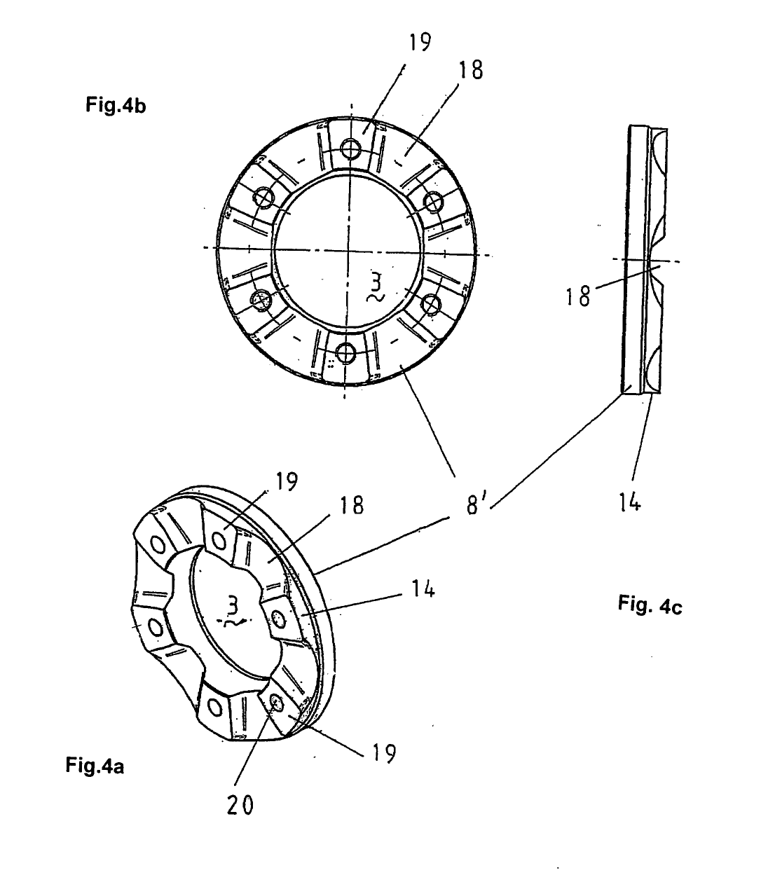

FIGS. 5a, 5b and 5c are a perspective view, a front view in the axial direction and a side view, partially sectional along line A-A of FIG. 5b, respectively of a locking assembly of a third embodiment of the invention; and

FIGS. 6a, 6b and 6c are a perspective view, a front view in the axial direction and a side view, respectively of the shrink disc according to FIGS. 5a, 5b and 5c.

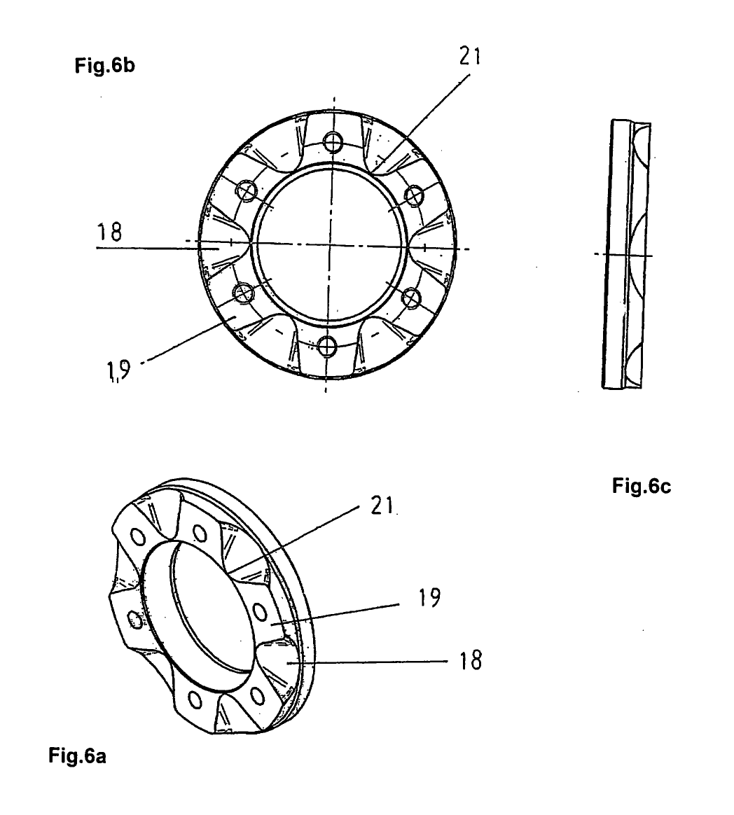

In the figures, equal parts are provided with the same reference characters.

### DESCRIPTION OF THE PREFERRED EMBODIMENTS

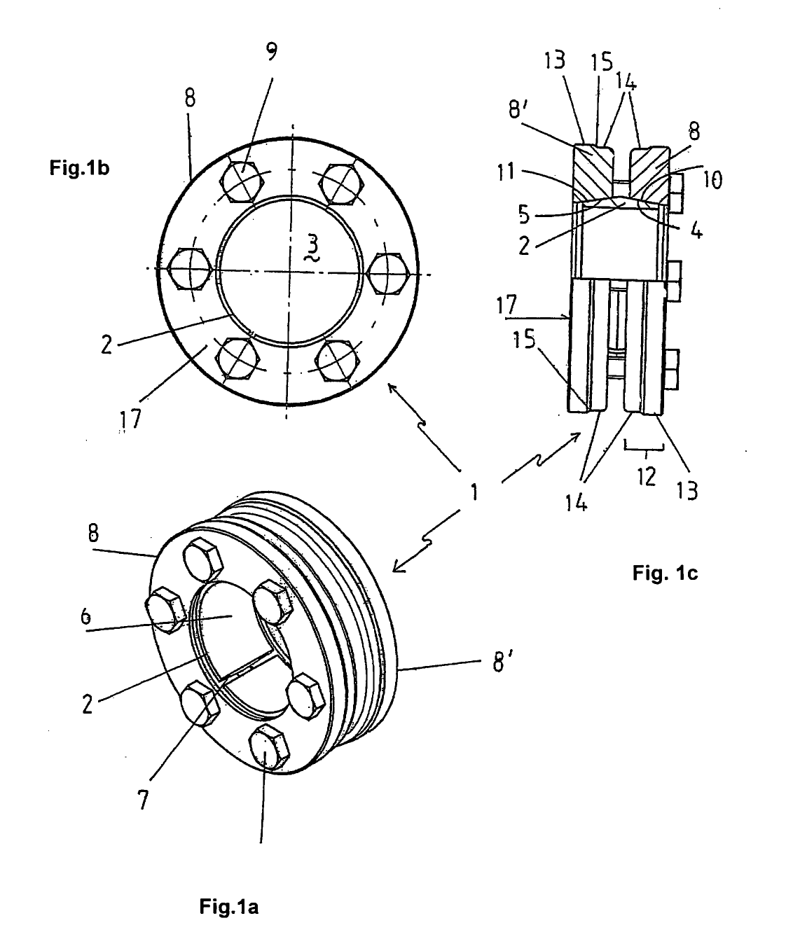

The shrink disc 1 illustrated in FIG. 1 is composed of a radially inwardly lying compression ring 2, two pressure rings 8, 8′, and six tightening screws 9 extending in the axial direction and uniformly distributed in the circumferential direction.

The compression ring 2 extends around a central, traversing bore 3, which can be pushed onto a hollow shaft, or a projection, or the like (not shown). The hollow shaft, or projection, can then, in turn, surround a shaft (likewise not shown).

The compression ring 2 has on its outside surface an inclined, conical surface portion 4 and an oppositely inclined, conical surface portion 5. The inside 6 of the compression ring 2 is cylindrical. The compression ring 2 additionally has a gap 7 extending in the axial direction.

The pressure rings 8, 8′ situated radially outwards from the compression ring 2 are likewise formed conically, on their insides, with the conical surface 10 of pressure ring 8 being inclined oppositely to the conical surface 11 of pressure ring 8′.

Conical surface 10 of pressure ring 8 interacts, in such case, with the conical surface portion 4 of the compression ring 2, while the conical surface 11 of pressure ring 8′ interacts with the conical surface portion 5 of compression ring 2.

Serving for tightening the shrink disc are a plurality of tightening screws 9 arranged uniformly distributed in a circle on the disc. These extend from one side, through bores in the pressure ring 8, into threaded bores in pressure ring 8′. The tightening screws are machine screws. Upon tightening the tightening screws 9, the pressure rings 8, 8′ are moved toward one another, or drawn together, in the axial direction. In such case, the conical surfaces 10 and 11 slide on the conical surfaces portions 4 and 5, respectively, with which they interact, and transfer, in so doing, radially inwardly directed forces to produce the desired shrink, or frictional, interlocking.

The outsides 12 of the pressure rings 8, 8′ are divided into an axially outwardly lying, ring region 13 and an axially inwardly lying, ring region 14. Situated at the location where the two ring regions 13, 14 abut with one another is a shoulder 15. For clarifying this matter, one can think of each of these pressure rings 8, 8′ as being composed of two mutually abutting rings of different outer diameters. Such a way of thinking serves, however, only for purposes of explanation, because each pressure ring is, of course, formed as one piece.

The pressure rings 8, 8′ are manufactured by forging in a die having a shoulder. This shoulder in the die then leads to the shoulder 15 on the pressure rings 8, 8′.

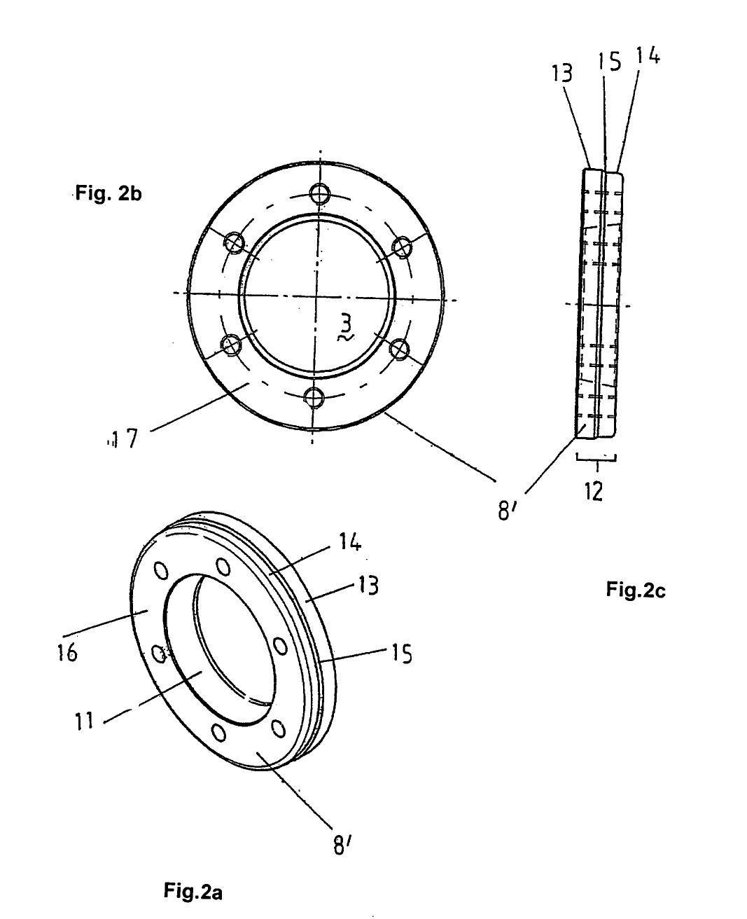

In the axially inwardly lying, ring region 14 and on the axially inwardly lying face 16 (compare also FIG. 2), the pressure rings 8, 8′ are untreated, so that it is unmachined, forged surfaces, which are seen there.

In the axially outwardly lying, ring region 13 and in the region of the axially outer face 17, the pressure rings 8, 8′ are smooth and shine like chrome. This appearance results from the turning, or cleaning and then turning, as described above. Naturally, the pressure rings 8, 8′ also have smooth surfaces in the regions of the conical surfaces 10, 11.

Since an untreated, forged surface looks dull and dark, and thus other than the way a treated surface looks, one can also recognize a shrink disc of the invention optically, even in an assembled state, since at least the ring regions 14 of the pressure rings 8, 8′ are still directly visible in the assembled state.

In the case of the pressure rings 8, 8′ shown in FIG. 1, the outer diameters in the ring regions 13, 14 are constant in the axial direction. In other words, the outsides of the pressure rings 8, 8′ are cylindrical. It is, however, also possible to allow the outer diameters of the pressure rings 8, 8′ to lessen in the axially inwards direction, so that the outsides of the pressure rings 8, 8′ are inclined in the ring regions 14.

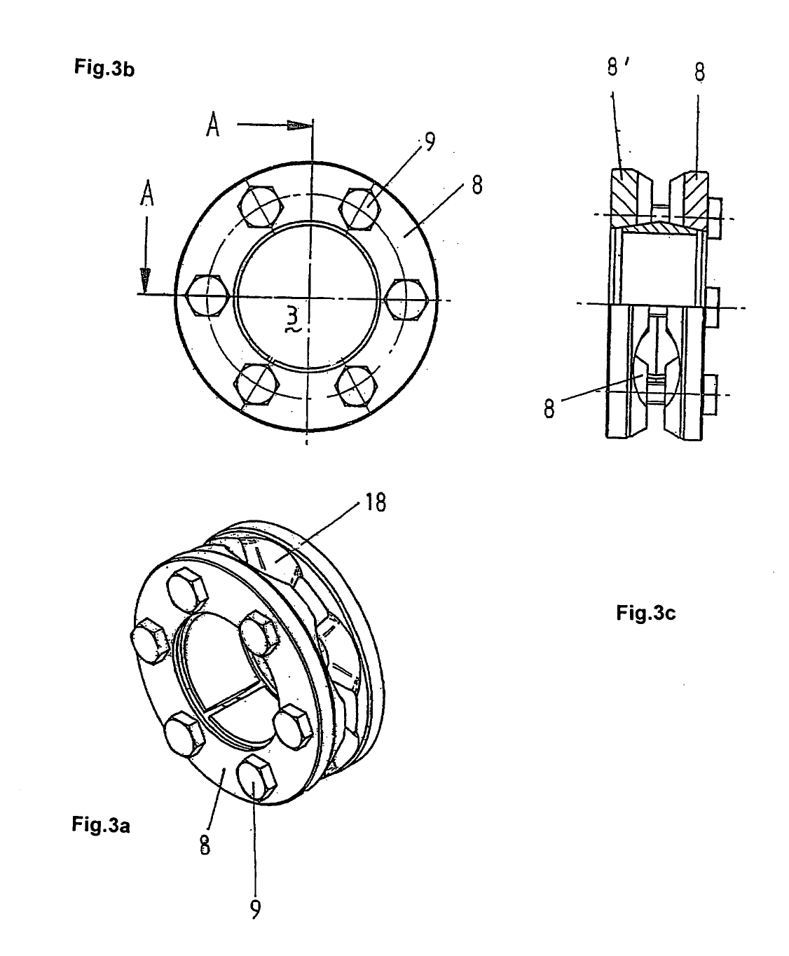

The shrink disk of FIG. 3 differs from that shown in FIG. 1, among other things, by the presence of depressions 18 in the pressure rings 8, 8′. These are trough-shaped depressions, which extend from the axially inwardly lying, ring region 14 radially inwards and run in the region between the tightening screws 9. Thus, these trough-like depressions 18 begin radially on the outside and extend radially inwardly into the central bore 3. As they extend radially from the outside toward the inside, they taper narrower. All that remains of the axially inner faces 16 of the pressure rings 8, 8′ are the sections 19 in the areas of the bores 20 for the tightening screws 9. In front view, sections 19 have a trapezoidal shape. The trough-like depressions 18 run between these trapezoidally shaped sections 19.

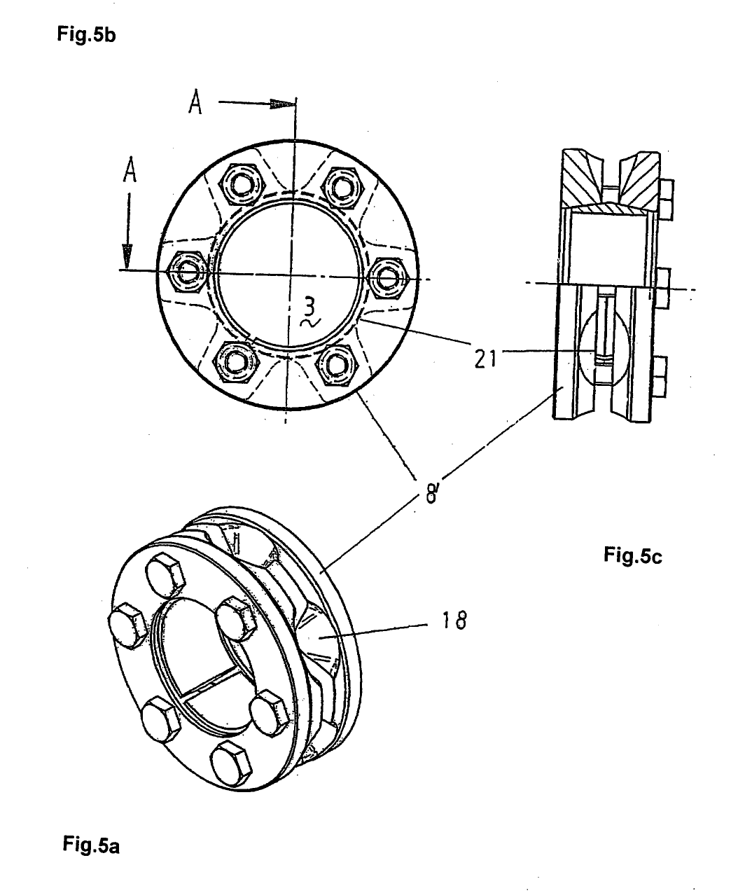

The shrink disc of FIG. 5 differs from the shrink disc of FIG. 3 only in the shape of the depressions 18, which do not traverse trough-like, radially from the outside to the inside, but, instead, have about the shape of a “half bowl” and, thus, have a kind of floor 21 on the radially inner side. The two oppositely lying depressions of the two pressure rings 8, 8′ form together, thus, a sort of pot, whose side walls widen in funnel shape as one proceeds radially outwards.

Since the pressure rings 8, 8′ are at least partially manufactured by forging, naturally they are made of a metal material suited for forging.

1. A Locking assembly for shrink, or frictional, connecting of a shaft with a hollow shaft or the like, comprising:
a radially inwardly lying, compression ring, whose outside surface includes at least one conical surface portion;
at least one radially outwardly lying, pressure ring, whose inside surface includes a conical surface portion, which interacts with the conical surface portion of said compression ring, so that, upon axial tightening, said compression ring is compressed, wherein:
said pressure ring is a forged pressure ring, and the surface of the forged pressure ring, at least on its outside, is at least partially untreated.

2. The locking assembly as claimed in claim 1, wherein:
the outside surface of said pressure ring includes an axially outwardly lying ring region and an axially inwardly lying ring region, and
the surface of said forged pressure ring is untreated in said ring regions.

3. The locking assembly as claimed in claim 2, wherein:
said axially inwardly lying ring region of said outside surface of said pressure ring is untreated.

4. The locking assembly as claimed in claim 2, wherein:
said pressure ring has in the axially inwardly lying ring region a smaller outer diameter than in the axially outwardly lying ring region.

5. The locking assembly as claimed in claim 3, wherein:
extending radially inwardly from the axially inwardly lying, ring region are depressions, or recesses, which are uniformly distributed in the peripheral direction.

6. The locking assembly as claimed in claim 5, wherein:
the inner diameter of said depressions decreases radially inwardly.

7. The locking assembly as claimed in one claim 1, wherein:
the surface of said axially inner face of said pressure ring is untreated.

8. The locking assembly as claimed in claim 1, wherein:
the outside surface of said compression ring is embodied as a double cone having two conical surface portions;
two pressure rings are provided having oppositely inclined, conical surface portions, each of which interacts with an associated conical surface portion of said shrink disc; and
said two pressure rings are forged pressure rings.

9. The locking assembly as claimed in claim 8, wherein:
the two pressure ring are embodied, at least essentially, equally.
